(19) United States
(12) Patent Application Publication
(10) Pub. No.: US 2011/0297121 A1
(43) Pub. Date: Dec. 8, 2011

(54) SPARK PLUG WITH A LASER DEVICE IN A PRECHAMBER

(76) Inventors: Markus Kraus, Wiesng (AT); Martin Weinrotter, Stuttgart-Botnang (DE); Pascal Woerner, Stuttgart (DE); Juergen Raimann, Weil Der Stadt (DE); Friedrich Gruber, Hippach (AT)

(21) Appl. No.: 13/139,987

(22) PCT Filed: Dec. 1, 2009
(86) PCT No.: PCT/EP09/66132

§ 371 Date: Aug. 25, 2011

(30) Foreign Application Priority Data
Dec. 16, 2008 (DE) 102008062572.8

(51) Int. Cl. F02B 19/12

(52) U.S. Cl. 123/260

(57) ABSTRACT

A spark plug is described, for an internal combustion engine, having a prechamber for accommodating an ignitable medium, and having a laser device for applying laser radiation to an ignition point situated in the prechamber. The laser device has a laser-active solid body having a passive Q-switch.

### FIELD OF THE INVENTION

The present invention relates to a spark plug for an internal combustion engine having a prechamber for accommodating an ignitable medium, and having a laser device for applying laser radiation to an ignition point situated in the prechamber.

### BACKGROUND INFORMATION

A spark plug of the type named above is discussed, for example, in German patent document DE 10 2006 018 973 A1.

### SUMMARY OF THE INVENTION

An object of the exemplary embodiments and/or exemplary methods of the present invention is to improve a spark plug of the type named above so as to ensure a more flexible operation and, simultaneously, a reliable ignition of an ignitable medium.

In a spark plug of the type named above, this object is achieved according to the present invention in that the laser device has a laser-active solid body having a passive Q-switch. This configuration makes it possible for the spark plug according to the present invention to produce high-energy laser pulses directly in situ, i.e. in the spark plug itself, so that the high-energy laser pulses required for an ignition do not have to be conducted to the spark plug from a remotely situated source via corresponding light conductors, and losses associated therewith do not occur.

Rather, in the configuration according to the present invention of the spark plug it is completely sufficient to supply the spark plug, or the passively Q-switched laser device situated therein, with pumped light, which has a relatively low peak power compared to the laser pulses required for the ignition and can be provided particularly economically for example from a remotely situated pumped light source.

According to the exemplary embodiments and/or exemplary methods of the present invention, the laser device integrated into the spark plug can advantageously have allocated to it a coupling optics for coupling the locally produced laser radiation into the prechamber.

The coupling optics can contain a focusing optics for focusing the laser radiation produced locally in the spark plug according to the present invention onto at least one ignition point situated in the prechamber, and/or can contain a combustion chamber window. An integration of the focusing optics into the combustion chamber window is also possible.

According to a further variant of the spark plug according to the present invention, a focusing optics having an adjustable focal length can quite particularly advantageously be provided. This adjustable focusing optics may be configured such that the focal length can be adjusted even in the installed state, i.e. when the spark plug according to the present invention is for example screwed into the cylinder head of an internal combustion engine.

As an alternative to this, a focusing optics having a fixed focal length may also be used in the spark plug according to the present invention. In this way, the precise position of the ignition point inside the prechamber can be influenced, at least during the manufacture of the spark plug according to the present invention, by a corresponding selection of the fixed focal length.

In a further very advantageous specific embodiment of the spark plug according to the present invention, it is provided that the focusing optics is fashioned such that the laser radiation is focused on an ignition point that, given a partitioning of the prechamber into three subareas that are approximately equal in volume and that extend axially away from an end face of the laser device that adjoins the prechamber and that are separated from one another by imaginary planes that run essentially parallel to the end face, lies in the subarea that is situated furthest from the end face. Given such a configuration, according to tests carried out by applicant the greatest possible efficiency and reliability of the ignition of the combustible medium in the main combustion chamber is provided by an optimized conversion of the chemical energy stored in the prechamber. In particular, here the quantity of gas is minimized that remains uncombusted by the flame front that occurs during ignition in the prechamber, and is therefore ejected from the prechamber into the combustion chamber without being used.

A further advantageous specific embodiment of the spark plug according to the present invention has a connection for a light conductor device via which pumped light from a pumped light source, which may be remotely situated, can be supplied to the laser device. The connection for the light conductor device may be configured as a locking connection and/or screwed connection and/or plug connection. Furthermore, it is conceivable that the light conductor device be connected undetachably to the laser device via the connection, and that the light conductor device be integrated into the laser device so as to be combined therewith during the manufacture of the spark plug according to the present invention.

A particularly simple manufacture of the spark plug according to the present invention, and a high degree of operational reliability, is provided if the laser device is designed monolithically. That is, the laser-active solid body, the passive Q-switch, the coupling-in and coupling-out mirrors and optics for coupling in or coupling out that may be present, as well as optical amplifiers, are essentially fashioned in one piece, or are combined with one another to form a monolithic construction.

In a further, very advantageous, variant of the spark plug according to the present invention, a wall segment adjoining the prechamber has at least one overflow channel that enables a fluid connection to a combustion chamber of the internal combustion engine. On the one hand, the ignitable medium can flow from the combustion chamber into the prechamber through this overflow channel. On the other hand, after an ignition of the ignitable medium in the prechamber, the overflow channel allows high-energy ignition flames to exit from the prechamber into the combustion chamber of the internal combustion engine, so that even a relatively lean mixture can reliably be ignited in the combustion chamber of the internal combustion engine.

Advantageously, at least one overflow channel of the spark plug according to the present invention can be fashioned as a swirl channel in order to impress a tangential movement component, relative to a longitudinal axis of the prechamber, onto a fluid flowing through the channel; in this way, in particular during loading of the prechamber a relatively good mixture results of the medium flowing from the combustion chamber of the internal combustion engine into the prechamber with the medium already in the prechamber.

In another very advantageous specific embodiment of the spark plug according to the present invention, it is provided that at least one inlet valve is provided for introducing a fluid, in particular the ignitable medium, into the prechamber. In this variant of the present invention, the prechamber can accordingly be charged directly with the ignitable medium (“rinsed prechamber”), so that for example no suctioning is necessary of an ignitable mixture from a combustion chamber of the internal combustion engine through the overflow channels into the prechamber in order to form an ignitable mixture there as well. Prechambers that are supplied with ignitable mixture from the combustion chamber solely via the overflow channels are also referred to as “unrinsed prechambers.”

Although the prechamber of the spark plug according to the present invention, in particular given use in stationary engines or large gas engines, etc., may be an integral component of the spark plug or is formed by the spark plug itself, according to a further variant of the present invention it can also be provided that a wall segment that limits the prechamber, in particular at the combustion chamber, is formed at least partly by the cylinder head and/or is an integral component of the cylinder head. That is, in this case subareas of the cylinder head and of the spark plug work together in a suitable manner to form the prechamber of the spark plug according to the present invention.

The prechamber can also be fashioned as a separate component. In this case, the prechamber can be connected to the spark plug for example via a screwed connection. Likewise, the prechamber can have a screwed connection for connection to a cylinder head.

In addition, it is conceivable to realize the prechamber in one piece with the spark plug or with a housing of the spark plug.

Further features, possible uses, and advantages of the present invention result from the following description of exemplary embodiments of the present invention shown in the Figures of the drawing. All described or represented features, in themselves or in arbitrary combination, form the subject matter of the present invention, independent of their summarization in the patent claims or the dependencies thereof, and independent of their formulation or representation in the description or in the drawing.

### BRIEF DESCRIPTIONS OF THE DRAWINGS

FIG. 1 shows a first specific embodiment of a spark plug according to the present invention in a partial cross-section.

FIG. 2 shows an enlarged representation of a part of the spark plug according to FIG. 1.

### DETAILED DESCRIPTION

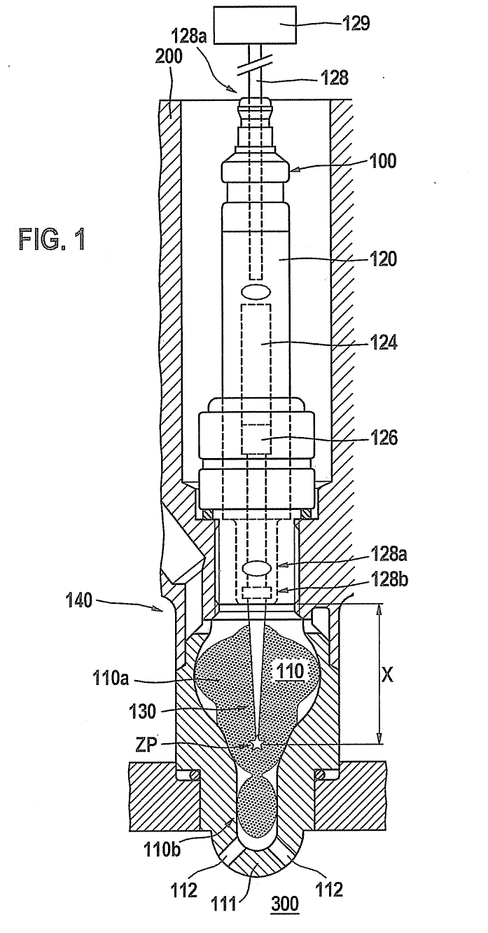

FIG. 1 shows a first specific embodiment of spark plug 100 according to the present invention. Spark plug 100 has a prechamber 110 that can be charged with an ignitable mixture via an inlet valve 140. In order to ignite the ignitable mixture in prechamber 110, spark plug 100 has a laser device 120 that in the present case is realized monolithically and has a laser-active solid body 124 having a passive Q-switch 126.

Via a connection 128a, spark plug 100 is connected to a light conductor device 128 that supplies pumped light from a remotely situated pumped light source 129 to laser device 120, which is integrated into spark plug 100. While the pumped light from pumped light source 129 is applied to laser-active solid body 124 or passive Q-switch 126, a laser pulse 130 is produced in a known manner, said pulse being coupled from laser device 120 into prechamber 110 via a coupling-in optics 128a, 128b. The coupling-in optics may have a focusing optics 128a for focusing laser radiation 130 onto ignition point ZP. In addition, the coupling-in optics has a combustion chamber window 128b that terminates laser device 120 of spark plug 100 at its end face toward prechamber 110.

The position, illustrated in FIG. 1, of ignition point ZP in prechamber 110 at a distance X (see the double arrow in FIG. 1) from the end face of laser device 120 at the combustion chamber advantageously ensures that as large a portion as possible of the ignitable mixture contained in prechamber 110 is ignited by laser radiation 130 in prechamber 110. In FIG. 1, this portion is designated by reference character 110a, and contributes to the ignition energy provided by prechamber 110.

A relatively small portion of the medium contained in prechamber 110, which as a rule is ejected uncombusted from prechamber 110 through overflow channels 112 into combustion chamber 300 of the internal combustion engine, is designated by reference character 110b in FIG. 1, and contributes to the so-called overflow losses.

The. selection according to the present invention of the position of ignition point ZP in prechamber 110 ensures, as can be seen in FIG. 1, that as great a quantity 110a as possible of the ignitable mixture contained in prechamber 110 is combusted, and only a relatively small portion 110b is ejected uncombusted from prechamber 110 into combustion chamber 300.

On the basis of the use according to the present invention of laser device 120, the position of ignition point ZP in prechamber 110 can advantageously be determined for example by the selection of the focal length of focusing optics 128a. In this way, it is advantageously always possible to select the favorable location for ignition point ZP as a function of further parameters.

According to a further variant according to the present invention of spark plug 100, a focusing optics 128a having an adjustable focal length can quite particularly advantageously be provided. Here, the adjustable focusing optics may be configured such that the focal length can be adjusted even in the installed state, i.e., when the spark plug according to the present invention is for example screwed into cylinder head 200 of an internal combustion engine.

Although prechamber 110 of spark plug 100 according to the present invention, in particular given use in stationary engines or large gas engines, etc., may be an integral component of spark plug 100 or is formed by spark plug 100 itself, according to a further variant of the present invention it can also be provided that a wall segment 111 that limits prechamber 110, in particular at the combustion chamber, is formed at least partly by cylinder head 200 and/or is an integral component of cylinder head 200. That is, in this case subareas of cylinder head 200 and of spark plug 100 work together in a suitable manner to form prechamber 110 of spark plug 100 according to the present invention.

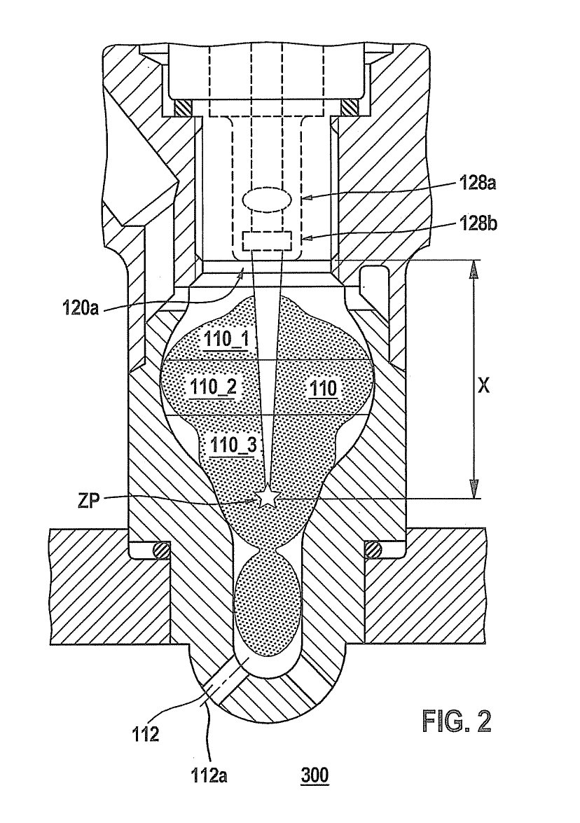

FIG. 2 shows an enlarged view of spark plug 100 from FIG. 1.

According to the present invention, the overall volume of prechamber 110 is divided into three regions 110_1, 110_2, 110_3 by imaginary planes that are situated essentially parallel to end face 120a of laser device 120 (FIG. 1). As is shown in FIG. 2, these regions 110_1, 110_2, 110_3 extend away in the axial direction from end face 120a of laser device 120 (FIG. 1).

In order to ensure an optimal operation of spark plug 100, in a variant of the present invention, the focal length of focusing optics 128a is selected such that ignition point ZP is situated approximately in the center of third region 110_3, i.e., in that one of the three regions 110_1, 110_2, 110_3 that is situated furthest from end face 120a. In order to determine the center of third region 110_3, for example the center of gravity of the volume defined thereby can be observed.

In a further, very advantageous, variant of the present invention, at least one overflow channel 112 of the spark plug 100 according to the present invention can be fashioned as a swirl channel in order to impress a tangential movement component, relative to a longitudinal axis of prechamber 110, onto a fluid flowing through it; in this way, in particular during loading of prechamber 110 there results a relatively good mixture of the medium flowing from combustion chamber 300 of the internal combustion engine into prechamber 110 with the medium already in the prechamber.

1-10. (canceled)

11. A spark plug for an internal combustion engine, comprising:
a prechamber for accommodating an ignitable medium; and
a laser device for applying laser radiation to an ignition point situated in the prechamber, wherein the laser device has a laser-active solid body having a passive Q-switch.

12. The spark plug of claim 11, wherein a coupling-in optics for coupling the laser radiation into the prechamber is allocated to the laser device.

13. The spark plug of claim 12, wherein the coupling-in optics includes at least one of focusing optics for focusing the laser radiation onto at least one ignition point situated in the prechamber, and a combustion chamber window.

14. The spark plug of claim 13, wherein the focusing optics has an adjustable focal length.

15. The spark plug of claim 13, wherein the focusing optics is arranged so that the laser radiation is focused onto an ignition point, which, given a partitioning of the prechamber into three subareas that are approximately equal in volume and that extend axially away from an end face of the laser device that adjoins the prechamber and that are separated from one another by imaginary planes that run essentially parallel to the end face, is situated in the subarea that is furthest removed from the end face.

16. The spark plug of claim 11, wherein a connection for a light conductor device is provided via which pumped light from a pumped light source, which is remotely situated, can be supplied to the laser device.

17. The spark plug of claim 11, wherein the laser device is realized monolithically.

18. The spark plug of claim 11, wherein a wall segment that adjoins the prechamber has at least one overflow channel that enables a fluid connection to a combustion chamber of the internal combustion engine.

19. The spark plug of claim 18, wherein at least one overflow channel is configured as a swirl channel to impress a tangential movement component, relative to a longitudinal axis of the overflow channel, onto a fluid flowing through it.

20. The spark plug of claim 11, wherein there is at least one inlet valve for introducing a fluid, which is the ignitable medium, into the prechamber.
